(19) United States
(12) Patent Application Publication
(10) Pub. No.: US 2025/0298854 A1
(43) Pub. Date: Sep. 25, 2025

(54) METHOD FOR MATCHING FAMILIES, FRIEND SETS, HOUSEHOLDS, NEIGHBORS, GROUPS AND COMMUNITIES FOR SOCIAL INTERACTIONS AND TRANSACTIONS

(71) Applicant: Paul Breslow, San Carlos, CA (US)

(72) Inventor: Paul Breslow, San Carlos, CA (US)

(21) Appl. No.: 19/082,503

(22) Filed: Mar. 18, 2025

Related U.S. Application Data
(60) Provisional application No. 63/567,266, filed on Mar. 19, 2024.

(51) Int. Cl. G06F 16/9536; G06Q 50/00

(52) U.S. Cl. CPC G06F 16/9536; G06Q 50/01

(57) ABSTRACT

An embodiment of the present invention is a computer-implemented method for matching families, friend sets, households, neighbors, and communities for social interactions and/or transactions, comprising: storing, on a computer memory device, a plurality of datapoints containing demographic, preference, and other descriptive or relevant information to matching families, friend sets, households, neighbors, and communities for social interactions and transactions; assigning point weights to the plurality of datapoints; and calculating, by a processor, a matching score, classification, or alternative algorithmic output determining the similarities for two or more families, friend sets, households, neighbors, and communities.

### BACKGROUND

Methods for facilitating trading of services such as personal services have been described in the prior art patent literature.

For example, US2016/0371773 discloses a method to facilitate trading of objects by exchanging these objects between users (P) that offers or requests objects (s,k) in a way where reliable contact information between the users are provided only when the objects a one user request to offer and request match the object another user request to offer or request. In order to achieve this a method is provided in which all objects offered or requested are classified by an administrator in a classification system, When an object offered or requested by a user matches another users object, where match is determined in a calculation unit by comparison of the classified objects, then the users identifications are transferred to the respective users after having paid fee for getting the identification in form of contact details.

U.S. Ser. No. 11/610,279 discloses a close marketplace where the users' institutional affiliation, identity, and/or criminal record are verified in order to become members. Although an unregistered person may browse some of the posted listings, in order to buy, sell, contact, and/or meet another member of the marketplace, a person has to be affiliated with an approved institution, the person's real life identity has to be verified, and/or the person's criminal background has to meet a pre-determined criteria. The marketplace lowers the risk for the strangers who may want to interact with each other through a close circle of professionals. When two members are going to meet through the marketplace to buy and sell items, to rent, to be roommates, to date, etc., they have an assurance that each member has gone through a validation and verification process.

However, prior art methods suffer from limitations including the inability to match compatible parties for social interaction and lack of suitability for sharing, lending, and borrowing. There is a need for systems, processes, or companies that propose to match families or groups of people. There are various friendship and dating apps, but they are all for matching two individuals. From a sociological perspective, families selecting friends with similar kids could make the quality and permanence of the relationships greater, especially as the kids age. For instance, a mom's group for new moms might introduce two families with first kids the same age (and perhaps gender) While this is great, there is no easy way for identifying families with similar compositions and attributes other than by coming across them by chance (i.e. it is not very well organized/optimized/digitized).

### SUMMARY OF INVENTION

Therefore, the present invention creates a trusted, circular economy social network, which enables families, friend sets, households, neighbors, and community members to identify, trust, interact and transact with one another. As opposed to platforms that match two individuals for friendship or dating, we match groups of individuals so that the collective value of the interactions and/or transactions can be maximized. For instance, whereas two families with children might meet and become friends and sometimes help each other, our platform enables those families to easily identify many families that may have the potential to be much higher quality matches and friendships and to be able to transact or help each other in many more impactful ways. In the present invention, families is shorthand for any close communities, and communities can be defined as any aggregation of two or individuals.

According to an aspect of the present invention, there is provided a computer-implemented method for matching families, friend sets, households, neighbors, and communities for social interactions and transactions, comprising: storing, on a computer memory device, a plurality of datapoints containing demographic, preference, and other descriptive or relevant information comprising one or more of interests (like playing tennis), activities (like being on specific teams), need or interest in providing or using some services for matching families, friend sets, households, neighbors, and communities for social interactions and transactions; assigning point weights to the plurality of datapoints; and calculating, by a processor, a matching score or type for two or more families, friend sets, households, neighbors or communities.

The method can enable two or more families, friend sets, households, neighbors or communities to manually or automatically determine their similarity, proximity or affinity through a variety of approaches which include but are not limited to 1) assigning point weights to the plurality of datapoints; and calculating, by a processor, a matching score, 2) assigning classifications, 3) implementation of mathematical algorithms, 4) machine learning and artificial intelligence, and 5) user specified filtering.

### BRIEF DESCRIPTION OF THE DRAWINGS

FIG. 1 illustrates a method of matching according to an embodiment of the present invention.

FIG. 2 illustrates a database “home” screen, from which I can upload data, generate the matching scores, reports, and tables:

FIG. 3 illustrates 12 types of comparisons being done.

FIG. 4 illustrates a table showing a version of the points assigned for various shared attributes.

FIG. 5 illustrates a matching report.

### DETAILED DESCRIPTION

The invention is a method of matching a plurality of individuals for friendship and/or transactions. Specifically, it can be used for matching families, friend sets, households, neighbors, and communities with others for specific reasons of friendship and/or transactions. We calculate and present the results and commonalities to users in specific orders such that the user who is looking for friendship or for a specific service (e.g. carpooling or babysitting) can identify the best match and have the most trust and comfort in the top options—and therefore be more likely to transact with them and use/benefit the network.

The anticipated use of the present invention is to improve how families, friend sets, households, neighbors, and communities or members of a community are matched with each other for various interaction and transaction purposes. Prior art platforms for matching persons for dating are improved upon for a multi-person network which facilitates identifying partners for transacting services.

Parents experience many challenges and taking care of a family and kids is very hard. The present invention makes it easier, by enabling a) more friendships, and b) creating a large trusted network of people that can and will regularly help in a community. The purpose is to match: 1. multiple groups 2. where the group is typically (but not always) 2+ people. For instance, a single person might be interested to interact with another household of 2+ for friendship and/or transactions.

The present invention solves the problem of identifying families that have the most relevant and/or quantity of aspects in common, so as to make the process of finding highly compatible friend families 1) possible, 2) higher quality, 3) automated. The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description.

The ultimate social or “friend” use case is for identifying families that match so well that all family members are great friends with their counterparts—and the two families are part of a cohort. For instance, if we imagine two families, Family A with two kids, a boy in 8th grade and a girl in the 5th grade, and family B with the same configuration and attending the same schools with the same interests and extracurriculars, and where the parents had sufficient shared interests, that would be a strong match. Then, we can imagine some type of gradation or scoring of matches based on the various data. Parents would be presented matches based on the scoring, and they can review the matches, potentially search or filter for specific criteria, and then decide to initiate or respond to connection requests.

While the “friend” use case may use one combination of variables collected (likely most/all), the transaction use cases would use some subset of data. For instance, for Family A looking for carpools to school X or extracurricular Y, they might just need to know that someone else nearby (or along the way) needs to get to the same location, but a superior match might be where the kids are in the same school, grade, gender, and class, and have similar interests. Similarly, to the “friend” use case, the parents would be presented with a list of matches for each transaction type, and then they could search/filter/select.

The list of services could be almost anything for anyone, including but not limited to the following:
Carpool to school & extracurriculars
Before/After school care
Babysitting
Dinner sharing
Daycare
Pet sitting
House sitting
Handy help and tasks
Shopping
Toy & Tool sharing
Giving/getting free stuff
Garden/produce sharing

Additionally, from a transactional perspective, it easier to have trust/comfort and reasons for transacting with families with kids with similar attributes—there is a natural bond of being in similar situations. The quality of the matching is based not on only on the intrinsic family attributes/interests, but also their interest/need/willingness to engage in certain specific “needs” or transactions, i.e. two similar families that are interested in sharing service needs like carpools and after-school care and dinner prep are likely to be more useful to each other than two families that do not share the same “needs”.

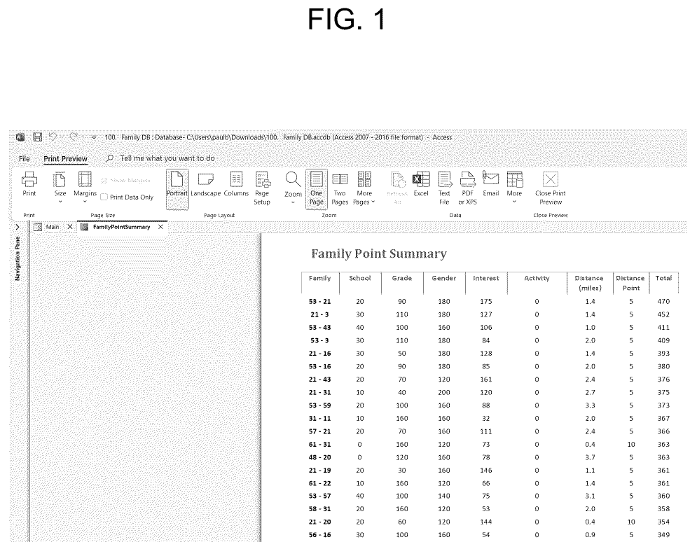

FIG. 1 is an example of the Family Point Summary that shows how families are assigned points based on the cumulative points in the various categories, e.g. matching schools, grades, gender, interests, extracurricular activities, and distance from each other.

Points are awarded for each and every combination of members of two families. The example focuses on comparing kids with kids and parents with parents, but comparing and identifying compatibilities amongst kids and parents together is also possible, i.e. a parent likes riding bikes and their kids and another family's does, and so they would be more apt to bike to school together.

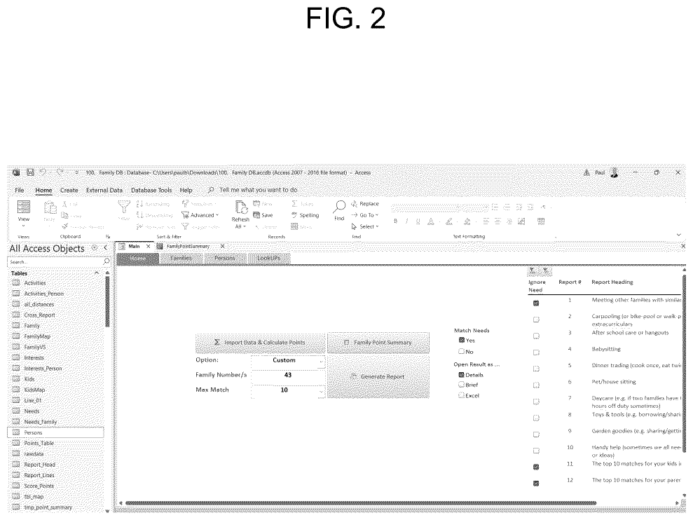

FIG. 2 illustrates a database “home” screen, from which it is possible to upload data, generate the matching scores, reports, and tables:

The points allocated for the various comparison attributes, e.g. 5 points for each interest in common can be varied.

The prioritization or combination of attributes that are applied to specific use cases of friendship or “needs” (transaction categories), e.g. we have different needs for a best friend family vs. what we might need/want from a family that provides babysitting or carpooling services for us can be varied.

The services that are being compared or offered, e.g. carpooling or toy/tool sharing can be varied.

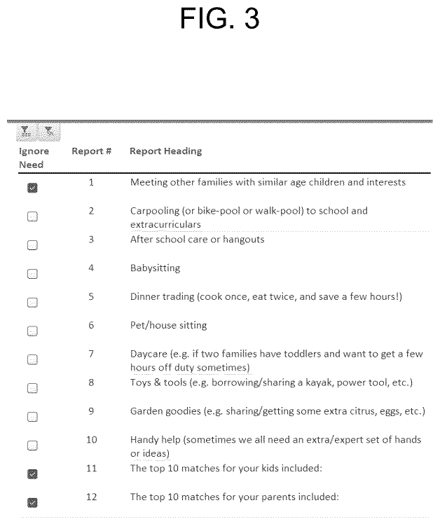

FIG. 3 illustrates 12 types of comparisons being done.

The attributes compared, e.g. gender, grade, school, interests like tennis/reading, distance can be varied.

The amount of the work that is automated by the platform vs. how much that users can customize, control, or sort the algorithm or results can be varied.

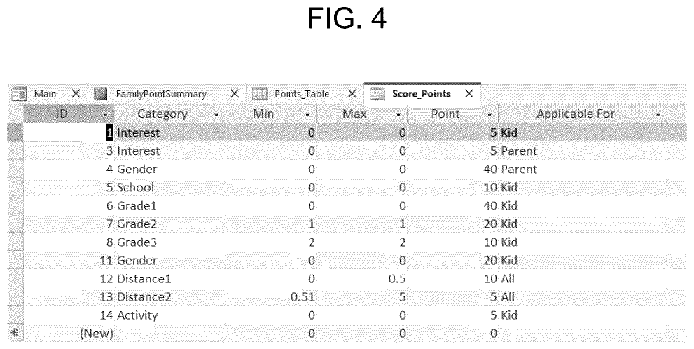

FIG. 4 illustrates a table showing a version of the points assigned for various shared attributes.

These values have been experimented with and are likely to change in the future, but they show the current embodiment of a score table.

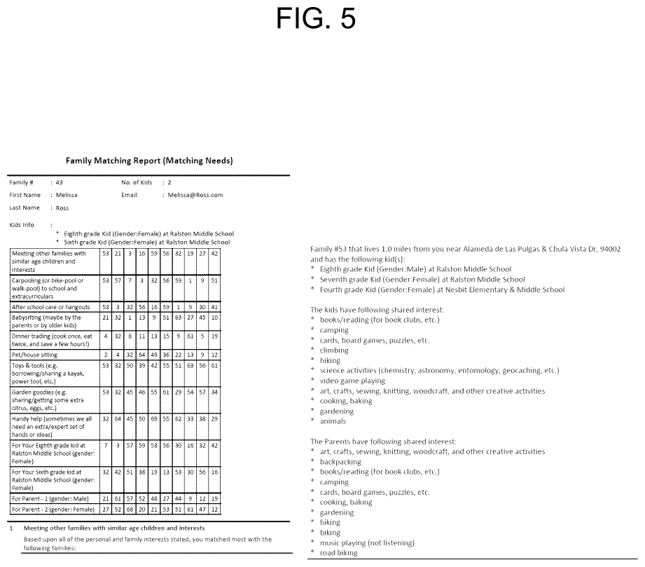

FIG. 5 illustrates a matching report.

It shows the top 10 families that match for each category that match with a family listed as Family 43. The full report shows the sorting and key data relevant for each “need” category.

Methods may include collecting, analyzing, aggregating, interpreting, inferring, and combining any combination of data directly entered into the platform by participants or by the platform operator, data gathered from the internet or through other sources, and data calculated through the platform's operation from data obtained as described above.

One key differentiator in the system is the ability to match families and groups not just based on direct similarities (e.g., same school, same interest), but also on non-obvious, related shared interests:

Interests that indirectly correlate: For example, someone interested in hiking may also be a good match for someone who enjoys camping or running.

Interests that foster compatibility across different members: For instance, if parents share common professional interests (e.g., both work in education), that might lead to a stronger overall family match, even if the kids don't have identical interests.

Cross-generational and hierarchical matching: A family with older kids who enjoy mentoring or tutoring might be matched with a family with younger children.

In some embodiments, clustering methods identify hidden relationships between interests.

One of the unique advantages of the system is trust-building in community-based transactions:

Trust scoring based on past interactions (e.g., reliability of a carpooling arrangement).

Friend-of-a-friend proximity scoring.

Some embodiments use ranking-based results, but there could be different ways to present match results dynamically in other embodiments, such as:

Graph-based representations of relationships.

“Discovery mode” where users explore connections visually.

Time-based or event-based weighting (e.g., matching families specifically for summer activities).

All of the above embodiments are designed to be conducted with artificial intelligence and machine learning. In general, machine learning algorithms are used to make a prediction or classification regarding inconsistencies and discrepancies in business sale transaction information. Based on some input data, which can be labeled or unlabeled, the algorithm will produce an estimate about a pattern in the data.

An error function evaluates the prediction of the model. If there are known examples, an error function can make a comparison to assess the accuracy of the model. A model optimization process then occurs. If the model can fit better to the data points in the training set, then weights are adjusted to reduce the discrepancy between the known example and the model estimate. The algorithm will repeat this “evaluate and optimize” process, updating weights autonomously until a threshold of accuracy has been met.

Supervised learning in particular uses a training set to teach models to yield the desired output. This training dataset includes inputs and correct outputs, which enables the model to learn over time. The algorithm measures its accuracy through the loss function, adjusting until the error has been sufficiently minimized. Thus, through the computer-implemented process described above, the present invention can improve its ability to predict and detect e.g., matches.

After training, the machine learning categorization engine processes the sensor data using pre-trained models trained on datasets of other matches and data evaluating them. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said prospective matches, wherein the AI/ML categorization engine makes a prediction regarding the match.

Other embodiments may be utilized and derived from this disclosure, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A computer-implemented method for matching families, friend sets, households, neighbors, and communities for social interactions and/or transactions, comprising:
storing, on a computer memory device, a plurality of datapoints containing demographic, preference, and other descriptive or relevant information to matching families, friend sets, households, neighbors, and communities for social interactions and transactions;
assigning point weights to the plurality of datapoints; and
calculating, by a processor, a matching score, classification, or alternative algorithmic output determining the similarities of two or more families, friend sets, households, neighbors, and communities.

2. The method of claim 1, wherein calculating by the processor entails one or more of 1) assigning point weights to the plurality of datapoints; and calculating, by a processor, a matching score, 2) assigning classifications, 3) implementation of mathematical algorithms, and 4) machine learning and artificial intelligence.

3. The method of claim 1, further comprising a filtering step according to user-defined filtering parameters.

4. The method of claim 1, further comprising displaying a match based on the matching score, classification, or alternative algorithmic output.

5. The method of claim 1, wherein the calculating step includes determining indirect or non-obvious commonalities between families, friend sets, households, neighbors, and communities by assigning point values to related but distinct interests and attributes.

6. The method of claim 2, wherein machine learning techniques, including but not limited to clustering algorithms, association rule learning, and neural networks, are employed to identify non-obvious interest correlations between families, friend sets, households, and communities.

7. The method of claim 1, wherein the point weights assigned to the plurality of datapoints are dynamically adjusted based on the context of the match, such that different weightings are applied for social interactions versus transactional interactions.

8. The method of claim 1, further comprising calculating a trust score for each family, friend set, household, or community entity based on prior interactions, social network connections, and verified transaction history.

9. The method of claim 1, wherein the results of the matching process are presented in one or more alternative formats, including but not limited to ranked lists, graphical social network representations, and time-based or event-based filtering.
